(19) United States
(12) Patent Application Publication
(10) Pub. No.: US 2013/0326050 A1
(43) Pub. Date: Dec. 5, 2013

(54) Method of Organic Cloud Discovery and Transformation of Network Assets

(71) Applicant: Christopher James Halabi, Plano, TX (US)

(72) Inventor: Christopher James Halabi, Plano, TX (US)

(21) Appl. No.: 13/485,915

(22) Filed: May 31, 2012

(51) Int. Cl. G06F 15/173

(52) U.S. Cl. 709/224

(57) ABSTRACT

A technology method that comprises the steps, methods and business rules of discovering network assets organically, decomposing the network into distinct layers and providing demarcation lines by normalizing the network assets into distinct cells, then mashing up the cells utilizing a Network Rules Engine to produce pre-packaged service capabilities by way of a graphical user interface and exposing these capabilities to the cloud.

### BACKGROUND OF THE INVENTION

This invention relates to methods for organically discovering and normalizing network elements and exposing them to the Cloud. Its purpose is to facilitate network management and migration concerning end-to-end service assurance and quality of service for network users. The inventive method allows for differentiation through best quality service and customer experience, faster network issue resolution time, and innovative support for migration and transformation programs. In particular, the invention aims to provide total control of the of network assets and to provide higher quality service to networks users. The invention provides a method for migrating and administering network assets.

Application innovators and providers are producing an enormous mass of value-added services using multi-Cloud environments for all fixed and mobile operators, ISP providers and enterprise and consumer end users. These applications increasingly stress the network and assume that the network (fixed and mobile) and its bandwidth, quality of service, and availability are assured. However, the new networked-world is divided into two spheres: the Cloud, with all of its applications, and the physical network. The network itself has become increasing more complex as a result of increased deployment of technologies to support the growing demand for bandwidth and throughput and added functionalities. Each layer of the network, including transmission, transport, switching and supporting systems, has become a multi-vendor, multi-legacy, multi-standards environment that requires extensive management and control. This invention aims to simplify network management, accelerate network changes and give the user control over the path of his traffic and rules for managing his End-to-End service assurance and the quality of the service for his application and his customers.

Current networks are overly complex. They have different vendors, generations of legacy technology, and a plethora of rules patched together to provide the backbone Cloud network that application and service providers need to function. FIG. 1 illustrates the complexity of the Cloud. Specifically, this illustration depicts an operator transmission and transport network provided by seven different equipment vendors (a simplified view) and supported by multiple Operation Support Systems (OSS) ranging from plan, build, assign, design and logical inventory, service fulfillment, workflow, domain management, test and diagnostics, trouble management and workflow. Each of the lines between the ten OSS systems and the seven network elements represents a unique interface that requires a massive human investment to understand each interface and its design and documentation, to write software code to compile these interfaces and to create specific libraries for run and execution times. To further illustrate this complexity, take the following example: an enterprise is providing content delivery services over the Cloud and is in the process of moving its data content from one data center to a second, global data center. Both data centers are supported by two different network providers, where additional capacity must be built in order to support the migration. Because the content is supporting triple play video for end retail and business customers, effective management of the quality of data migration and end user service assurance is crucial. It is also necessary to move financial and trading data from traders' desks to the Cloud, where response time becomes critical and end-to-end delay is inacceptable. The long-term key to effective networks would be the migration of the legacy telecommunication systems from their central offices or exchanges to virtual exchanges on the Cloud, which could be managed directly by third parties or by fiber-only exchanges.

### BRIEF SUMMARY OF THE INVENTION

An object of the invention is to provide a method that quickly and efficiently provides a platform, based on the rules of the network, that discovers and normalizes network elements and that exposes these elements to the Cloud in order to accelerate network transformation, migration, and administration.

Another object of the invention is to provide a method that introduces innovation and automation into a process that is otherwise workforce intensive and extremely prone to human error.

An additional object of the invention is to provide a method that provides the golden thread to fuse the Cloud's software and hardware in order to provide a seamless interface to the assets in the information systems network to support diverse applications.

An additional object of the invention is to provide a method that produces an abstract model of the network elements and that will define the contours of the network based solution (i.e. video contour, core network contour, access contour, customer premise contour, etc.).

A final object of the invention is to provide a method that allows the service creator to use a graphical interface and to assemble the cells into sequences of pre-packages capabilities that could be utilized to implement the service of his or her choice while exposing these capabilities on the Cloud and making them globally available.

Upon further study of the specification and appended claims, additional objectives, applications, and advantages of this invention will become apparent to those skilled in the art of the invention.

These objectives are achieved by the inventive method for organically discovering and normalizing network elements and exposing them to the Cloud.

### BRIEF DESCRIPTIONS OF THE SEVERAL VIEWS OF THE DRAWING

The advantages of the invention are best understood when considered with the following accompanying drawings:

FIG. 1 illustrates the hidden complexity of the Cloud by depicting an operator transmission and transport network provided by seven different equipment vendors and supported by multiple Operation Support Systems (OSS); and

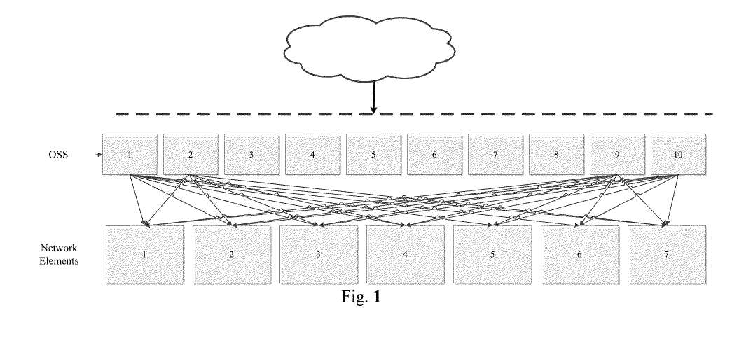

FIG. 2 illustrates the organic Cloud engine that will provide direct interfaces into the network elements and present a common and normalized interface where the subject matter expert could utilize his knowledge to write rules for managing the network assets; and

FIG. 3 illustrates the step-by-step solution of the organic Cloud engine including organic discovery, organic transformation, normalization, and pre-packaging based on business rules; and

FIG. 4 illustrates a more in-depth look at the solution.

FIG. 5 illustrates the general flow for discovering and transforming the network assets into a virtualized model; and

FIG. 6 illustrates the scenarios associated with network migration.

### DETAILED DESCRIPTION OF THE INVENTION

Network migration and transformation are beyond the expertise of most network administrators and all but a handful of network subject matter experts. An easy-to-use computer system for quickly and accurately building out the network system, without extensive prior knowledge of the network, should have a “user-friendly interface” and feature simple “drag-and-drop” elements to test and transform networks. Such a system would incorporate all network elements, regardless of vendor or legacy technology elements. Having a system with these characteristics would provide users with the ability to perform dynamic and adaptive service creation. Furthermore, having a system with the ability to organically build a view of the network and create “What if?” scenarios would allow for using both inputs and outputs to determine how changes affect the entire network topology, as well as for the ability to dynamically change the system. The inventive method explained below provides such a system.

Network providers, Cloud and hosting service providers, financial institutions, application store enterprises, and network administrators can use the inventive method. Because of increased reliance on the Cloud, every company that handles its own computer network will face those difficulties associated with network management and transformation. Because these network management activities are often labor and time intensive, network managers need to proceed in as efficiently as possible. This inventive method will perform network management and transformation activities in a flexible and efficient manner, alleviating any burden on resources.

For example, imagine a user is interested in undergoing a network migration program. The organic Cloud discovery method would simply management and execution of migration programs by introducing innovation into a process that is otherwise and workforce intensive and prone to human error. As there is a movement towards more flat IP networks, the fusion of central offices or exchanges with the Cloud data center concept, utilizing mobile data centers to facilitate transformation and migration, could employ the organic Cloud discovery concept.

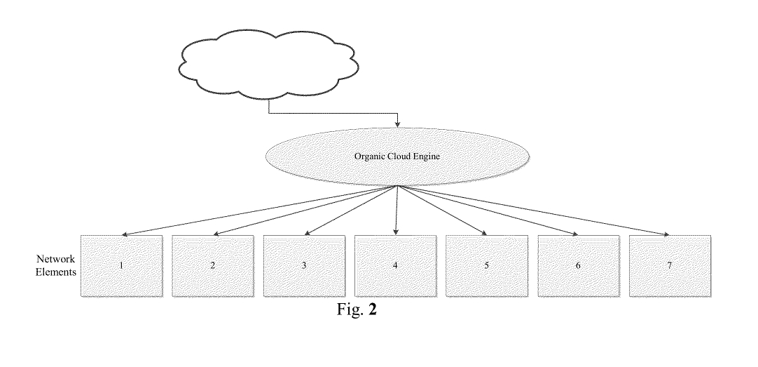

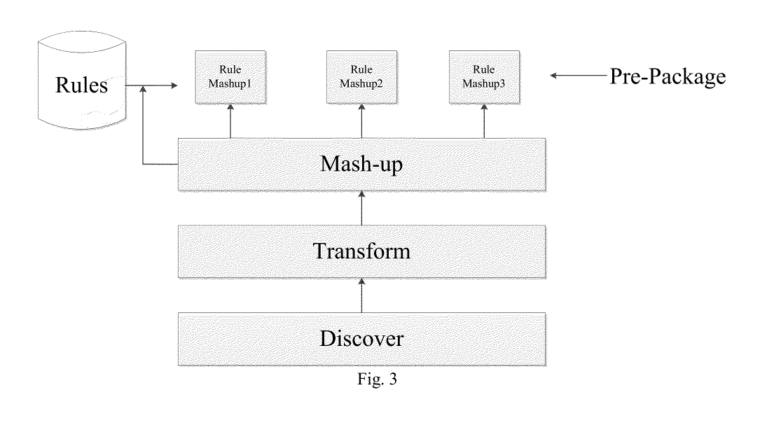

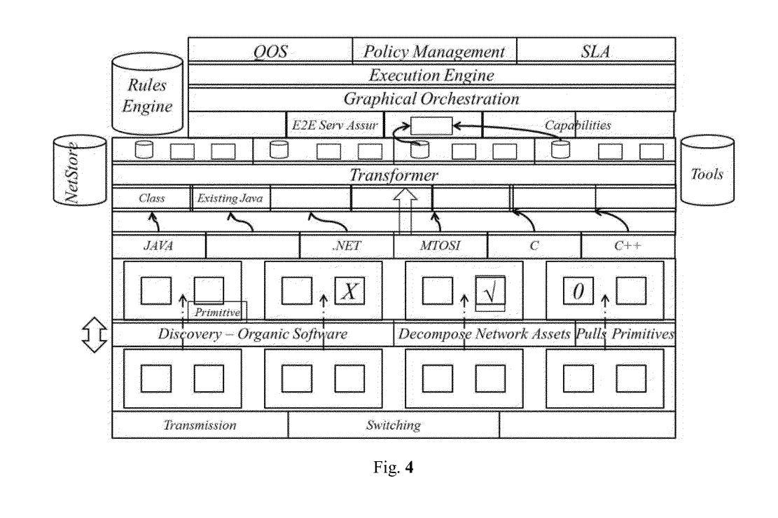

The inventive method relating to the organic Cloud discovery concept runs off of the organic Cloud engine. The diagram in FIG. 2 depicts the organic Cloud engine that will provide direct interfaces into network elements and present a common and normalized interface where the subject matter expert could utilize his knowledge to write rules for managing network assets. The organic Cloud is defined by specific business rules and methods that could be programmed automatically to provide the auto-discovery method, the transformation and normalization method, and the pre-packaging (mashing) of business rules (FIG. 3 FIG. 4), leading to the invocation and execution of user-defined rules. There have been many innovations for each layer of the Cloud: the customer relationship models, business support systems, operations support systems and network elements across transmission, transport, switching for both fixed and mobile. This invention provides the golden thread to glue and fuse the software with the hardware to provide seamless interface to the assets in the information systems and networks in support of diverse applications.

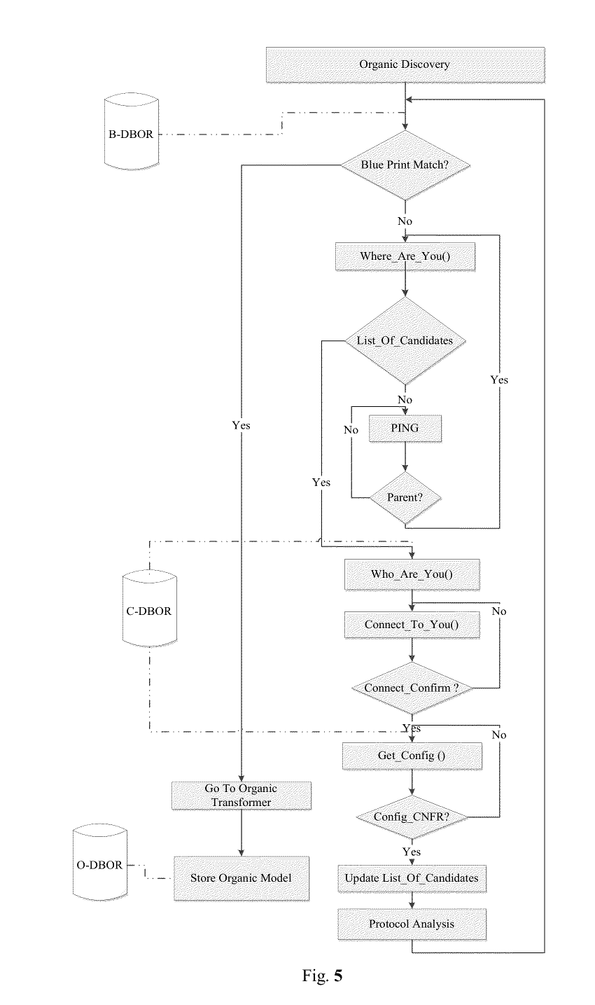

The inventive method creates an abstract model of the network, relying on the tool set described below, and is technology and vendor agnostic. FIG. 5 describes the control and data flow for discovering and transforming the network assets into a virtualized model. There is a toolkit of databases and algorithms required to make the discovery and virtual transformation of the network. For example, to illustrate how the inventive method words, consider an IPTV network. A setup box (STB) is an STB device regardless of the vendor specific model. An access device is an access device regardless of the specific vendor, release or version (GPON, BPON, DSLAM, FTTP DSLAM, FTTC DSLAM, etc.). An edge router is an edge router regardless of the vendor or the model. Therefore the sliding window used over the “Blueprint” (a template that could pertain to different end-to-end solutions and services provided over fixed or mobile networks) that must be discovered for the IPTV organic Cloud case are the following contours:
(1) Video content
(2) Core switching
(3) Edge switching
(4) Access
(5) Customer premises

In order to discover the network, the inventive method begins with a database of multiple “Blueprints” based on the different required applications. Therefore, the “Blueprint Database of Record” (B-DBOR) is the original database necessary to keep multiple virtual blueprints of the different instances of the physical network assets. Another database that is required to assist in the discovery and virtualization of the network is the Communicator Database of Record (C-DBOR) which consists of the different languages and protocols that network elements support (e.g. SNMP, .Net, MTOSI, WSDL, XML, V.21, X.21, CLI, SOAP/JMS, SOAP/HTTP, JAVA, C, C++, etc.). The discovery flow works as follows:
(1) It is assumed that all elements communicate using Internet protocol and IP pings are issued to the IPV4/6 addresses within the domain of interest. A tree is built with Parents IP nodes that become the initial focus of creating the first abstract view of the network.
(2) The Where-Are-You( ) function returns a List_Of_Candidates contours to be matched with the B-DBOR blueprints.
(3) The Who_Are_You( ) function issues Connect-To-You( ) (C-DBOR Argument) calls to the List_Of_Candidates contour utilizing a C-DBOR language entry until a match is achieved by getting returning Connect_Confirm.
(4) The process is repeated until connections to all the elements in the contour are identified.
(5) Once the communication is established, the Get_Config_Element( ) and Get_Config_Port( ) (collectively, Get_Config( )) functions help determine the abstract element that will be compared using the sliding window process with the entries in the List_Of_Candidates.
(6) The process of elimination starts with a software protocol analyzer that aids the elimination process to finally select the most likely blueprint. The software protocol analyzer (most core switches provides an interface to monitor the traffic going in and out of the switch) can be applied to the core switches and edge switches, in order to identify the boundary of the network.
(7) The final output of the discover process is an abstract model that is vendor-agnostic, but the connection and the communication is established to the element to prepare for the next step of organic interface model generation of the cells that will be the normalized interface to the elements in the model. The network model along with its specific connection, language and configuration is stored in the Organic Data Base of Record (O-DBOR).

Following organically discovering the network assets, the inventive method continues with an organic transformer. The organic discovery process produces an abstract model of the network elements that will define the contours, such as in the case of IPTV: the Video content, the core switching, the edge switching, the access, and the customer premise contour. The organic model is not limited and the same process and methods could be utilized to provide deep inspection of the sub-contours within each contour, an application that is very valuable and necessary for troubleshooting, diagnostics, and test applications. In addition to the abstract model of the network, the organic discovery process established and stored the connection and the configuration information to each abstract model in the O-DBOR. The concept of organic cells is introduced now to refer to the canonic interface to each network element in the abstract model. The Organic_Transformer implements the following process to create the normalized organic interface:
(1) For each element of the abstract model, the Organic_Transformer calls the function Get_Interface( ) that returns the interface specification for each primitive for the contour element lead.
(2) Then Organic_Transformer parses the code to create a pointer to the actual primitive interface header that is the actual run-time function call for that specific element. In addition, the data required for making the function call is stored in the same object/class as the pointer to the function.
(3) The Organic_Transformer creates a cell consisting of the object or class containing the pointer to the function along with the data that is required to load the function parameters. Now the interface to each element is normalized by creating cells that have the same syntax and semantics to each element; i.e. Connect, Get_Config, Get_Port_Status, Turn_Port_On, Turn_Port_Off, Get_Performance_Monitor, Activate_Port, etc. All of these cells are normalized and look and function the same for each element. All of the complexity of the internal run-time parameters and complexity are totally embedded in the original network interface as provided by the vendor.
(4) At the end of this stage the O-DBOR is updated with the cells associated with each element of the abstract models, and the cells contains the pointers to the run-time functions for each element without any requirements for specific interface design, development and compilation.
   This is the run-time engine that will be at the disposal of Cloud user, network operation centers, or migration centers. Now the job for the user of the network, whether it is a human or an intelligent Cloud application is to assemble and pre-package the cells into capabilities that are a sequence of cells to be executed.

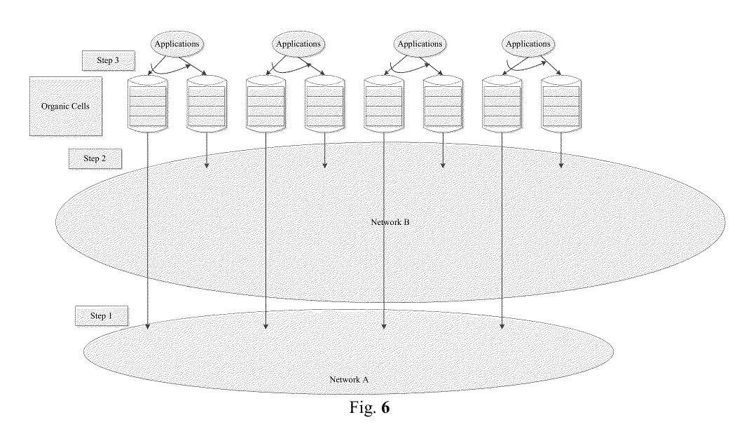

Furthermore, the Organic_Transformer has extremely powerful assets that can be leveraged to dynamically create services that are best illustrated by real and practical examples: service ordering, network migration, application to IPTV and Over-The-Top (OTP) Video, application to the financial banking industry. Prior to the examples, it is essential to understand that as a result of the method, the Organic Database of Record (O-DBOR) and organic Cloud engine consist of classes of cells for each network element that are run-time ready to execute. Creating new services and new products is a challenge for every enterprise whether it is in the networking, financial, or defense industries. The present mode of operations call for product experts to interface to service design experts who in turn have to negotiate with IT and network managers, who in turn must consult the vendors of both IT and network elements. Therefore, the cycle time for creating new products that utilize the network assets require an extensive human involvement and very long cycle time (eighteen to twenty four months on average). This invention allows the service creator to use a graphical interface and to assemble the cells into sequences of pre-packaged capabilities that can be directly utilized to implement the service of his or her choice while exposing all these capabilities on the Cloud and making them globally available. The following example will aid in the illustrating the benefits of the inventive method:
(1) Service ordering: An enterprise is accepting orders for service activation over the Cloud. In this situation, a user_ID begins the process. Using the user_ID, the inventive method starts by querying the inventory system to get the network domain for setting up a VLAN for the customer. The discovery is simple in this case as there are only two network elements involved: The OLT (Optical Line Terminating) device and FTTP DSLAM device. The Organic_Transformer automatically creates the cells required to turn the service on at the two elements, regardless of the interface spec as the organic discovery process determines that the languages involved are SNMP and MTOSI. The execution order desk creates the sequence of turning the service on at both ports (the OLT and the FTTP DSLAM). However, the project is not completed. Another sequence is created to do perform tests and diagnostics on both ports before providing the service for the customer. Service Ordering is the first step in the process of provisioning new customers or new service for existing customers. The same organic concepts apply to turning the service on and using another sequence of cells to retrieve performance from different element in the contour and to issue test and diagnostics commands to troubleshoot problems whether reported by the customer or proactively before the customer take notice.
(2) Network migration application: Network migration has been a very complex, tedious and risky endeavor that most operators avoid and undergo, only when no other option is available. The reason is that most companies acquire other smaller firms that have their own legacy networks and the assets get added to the bottom line of the mother company. Capital costs and operating costs to manage heterogeneous global networks become very costly and the mother company must invest into new leading edge technologies. It is plausible to consider moving or migrating customers from the old and acquired networks to the mother global network. FIG. 6 depicts the scenarios associated with migrating network A consisting of four different vendors to network B consisting of another set of vendors. As this is a migration program, the discovery gets fed to the organic discovery module and the organic transformer triggers and converts and normalizes the interface of the old network and the new one. It is a three step process:
   i. Step 1 normalizes the interface to vendors X1, X2, X3 and X4 into an organic cell store.
   ii. Step 2 consists of creating the organic cell store for vendors Y1, Y2, Y3 and Y4. Next, the migration occurs.
   iii. Step 3 begins the migration, with a swing of the interface from the old network A into the new network B.
   Service assurance consists of using the same organic interface to manage both networks and seamlessly moving the access from the old network A to the new network B. Because the organic software is hiding the specificity of the actual network elements, the up-steam applications never notice the migration, as they are still using the same interface.
(3) Application to IPTV and OTP Video: Content distribution and end-to-end management is a real challenge when traversing multiple underlying networks with different characteristics and many parameters. The inventive method can be applied to standard triple play, IPTV, OTP video because the end-goal in each scenario is the same: guarantee good quality of service and pick the route with the highest bandwidth, eliminate jitter and ensure quick recovery for lost video packets. After applying the organic discovery and transformation method to produce the organic cells that will manage the different end-to-end video boundaries, this application calls for assembling the cells to achieve end-toe-end service assurance function; a graphical user interface will be put at the disposal of the subject matter expert who will assemble the cells into a sequence of set of rules to be executed to achieve specific operational functions. For example, if an alarm is raised at the customer premise equipment, the following sequence of cells could be executed:
   i. get_alarm from Customer Premises
   ii. get_alarm from Access
   iii. get_alarm from Gateway.
   iv. If there are two alarms at both the Access and the Gateway then invoke the cell “reset_gateway”; this should clear all alarms automatically without the user having to contact the call center.
   v. Other pre-packaged capabilities beside E2E service assurance are QOS assurance, SLA agreement, end-to-end monitoring and end-to-end capacity management; all these service management functions could in turn be exposed to the Cloud.
(4) Application to the financial banking industry: In the banking world, there are multiple financial products that co-exist in the same banks and institutions. Applying the same organic concepts, every banking financial implementation can be viewed as consisting of common platforms to implement amortization, interest accrual, charges, shared applications such as loan application and account management, and finally teller functions as managing withdrawals and deposits. Many legacy systems are written in RPG, while newer systems make use of Java or other coding languages. The organic discovery functionality is straightforward here, and the Organic Transformer can be extended to map and normalize the interface into cells that provide the organic interface to manage all three elements of the banks common platform, shared applications and teller functions.
   As demonstrated above, the benefits to telecommunications companies, Cloud operators, network managers are evident:
(1) Differentiation by providing best quality service and customer experience.
(2) Reduced OPEX and achieve lower total Cost of Ownership (TCO) with a future proof Organic Cloud solutions,
(3) Increase Average Return Per User (ARPU) through agile and speedy introduction of new innovative services
(4) Faster network issue resolution time.
(5) Innovative support for migration and transformation programs.
   For any technology or vendor, the inventive method discovers network assets organically, decomposes the network into distinct layers and provides demarcation lines by normalizing the network assets into distinct cells, then mashing up the cells utilizing a Network Rules Engine to produce pre-packaged service capabilities by way of a graphical user interface and exposing these capabilities to the Cloud.

The invention in which an exclusive right is claimed is defined by the following:

1. A technology method for discovering the network assets organically facilitating network migration technology through the use of Organic Cloud Discovery software, comprising the steps of:
a. Discovering the Network assets;
b. Decomposing the Network into layers/verticals (e.g.):
i. Content
ii. Core
iii. Access
iv. End User
c. Pulling the Network interfaces together using the Organic Software;
d. Normalizing the Network interface primitives into cells (Organic Transformer Software);
e. Mashing-up the cells, incorporating associated network database rules and prepare the execution engine;
f. Producing pre-packaged Network Store capabilities
g. Exposing the Network Store capabilities and execution engine to the Cloud.

2. The method of claim 1, wherein the software organically discovers all network assets for the network in use.

3. The method of claim 2, further compromising the step of storing information related to the discovery of hardware, middleware, and software network asset settings in one of a local storage memory and a remote storage memory.

4. The method of claim 3, wherein the discovered information consists of specific network settings.

5. The method of claim 4, wherein the specific network settings, the step of ensuring the security of the information is indicated.

6. The method of claim 1, wherein the discovered network assets are separated into the different network layers.

7. The method of claim 1, wherein the separated, discovered network assets are pulled together using normalized cells.

8. The method of claim 1, wherein the normalized cells are modified to become pre-packaged solutions.

9. The method of claim 1, wherein the pre-packaged cells are mashed-up with the associated network database rules.

10. The method of claim 9, further compromising the steps of preparing the execution engine with the network cells.

11. The method of claim 1, wherein the pre-packaged cells are stored into a “Network Store”.

12. The method of claim 1, wherein the “Network Store” and execution engine are exposed to the Cloud via a drag-and-drop graphical user interface.
